(19) United States
(12) Patent Application Publication
(10) Pub. No.: US 2010/0170404 A1
(43) Pub. Date: Jul. 8, 2010

(54) Multiple Blade Accessory for a Food Processor

(75) Inventors: Keith James Hensel, New South Wales (AU); Garth Ryan, New South Wales (AU)

Correspondence Address: MICHAEL MOLINS;MOLINS & CO., SUITE 5, LEVEL 6, 139 MACQUARIE ST, SYDNEY NSW, 2000, AU

(73) Assignee: BREVILLE PTY LIMITED, Botany, NSW (AU)

(21) Appl. No.: 12/663,001

(22) PCT Filed: Jun. 4, 2008
(86) PCT No.: PCT/AU2008/000794

§ 371 Date: Dec. 3, 2009

(30) Foreign Application Priority Data
Jun. 4, 2007 (AU) 2007902986

(51) Int. Cl. A47J 43/04; B02C 18/18

(52) U.S. Cl. 99/537; 241/282.1

(57) ABSTRACT

A multiple blade accessory device for a food processor is provided. The accessory has a hollow hub that is adapted to carry a pair of lower blades and a pair of upper blades. The lower blades and the upper blades being similar, each formed from a single blank. Each blank is formed to present two cutting edges, diametrically opposed. The upper blade pair is moulded into a separate sleeve. The hub is adapted to be assembled with the sleeve.

### FIELD OF THE INVENTION

The invention relates to rotating blades and more particularly to a rotating blade attachment for a food processor.

### BACKGROUND OF THE INVENTION

A food processor has a processing bowl through which passes a motorised shaft. The shaft is adapted to receive a variety of accessories that are used to cut, mix or otherwise process ingredients in the bowl. The present invention seeks to provide an effective four bladed cutting accessory that is effective in use and economical to manufacture.

### OBJECTS AND SUMMARY OF THE INVENTION

It is an object of the invention to provide a blade accessory for a food processor that incorporates two pairs of blades, mounted above one another, each pair preferably comprising a single blank onto which two cutting edges are formed. In preferred embodiments, an upper pair of blades is carried by a sleeve that is manufactured separately and assembled onto a hub that carries a lower pair of blades.

### BRIEF DESCRIPTION OF THE DRAWING FIGURES

In order that the invention be better understood, reference is now made to the following drawing figures in which:

FIG. 1 is a perspective view of a blade accessory for a food processor;

FIG. 2 is an inverted perspective view of the device depicted in FIG. 1;

FIG. 3 is a cross-sectional view of the device depicted in FIG. 1; and

FIG. 4 is an exploded perspective view of the device depicted in FIG. 1.

### BEST MODE AND OTHER EMBODIMENTS

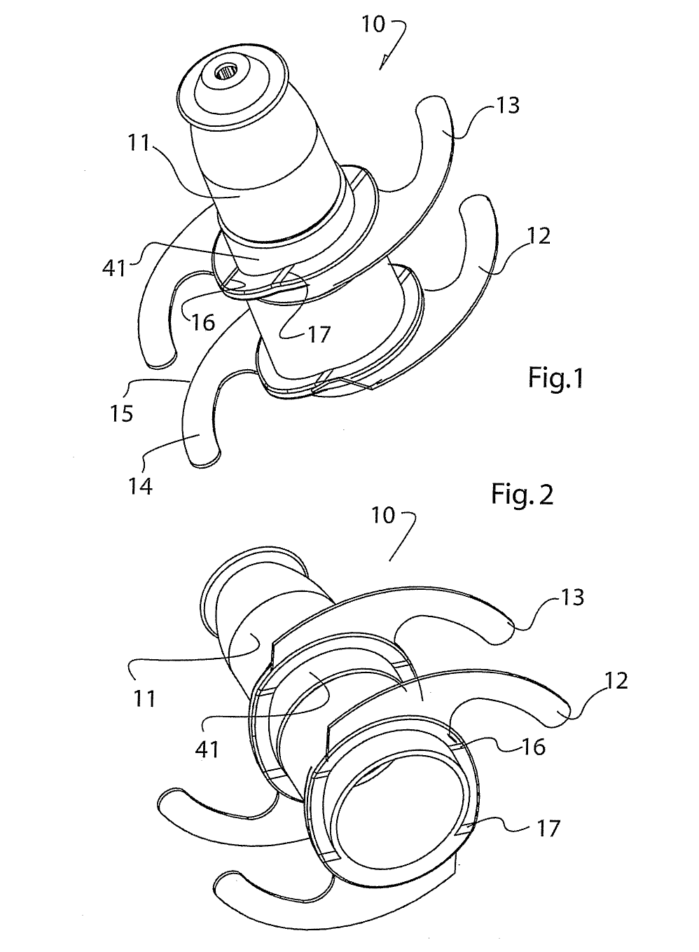

As shown in FIGS. 1 and 2, a four bladed food processing accessory 10 comprises a hollow hub 11 that is adapted to carry a pair of lower blades 12 and a pair of upper blades 13. In preferred embodiments, the lower blades 12 and the upper blades 13 are identical (or similar), each preferably and conveniently formed from a single blank. Each blank is formed to present two cutting edges, diametrically opposed. The blade pairs 12, 13 are arranged one above the other and in preferably vertical alignment. As will be explained, the cutting edges in each part are in different planes so the accessory presents four cutting planes.

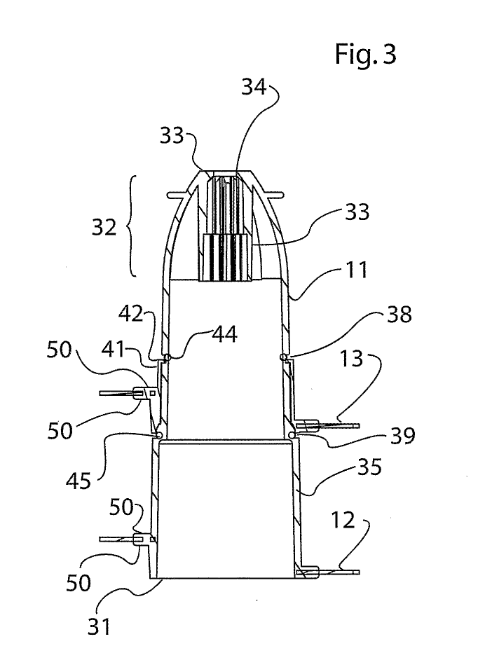

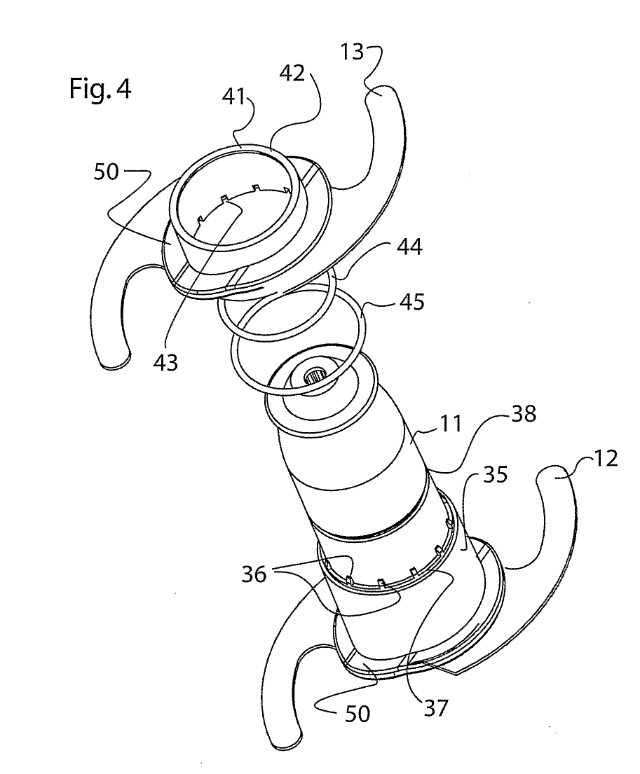

As shown in FIG. 3 the hub 11 comprises a relatively thin walled moulding having an open lower end 31 and a tapered tip 32. The tip 32 has a flat top end 33 in which is formed a central opening 34. The interior of the tip 32 comprises a negative of female spline 33 that is driven by a cooperating portion of the food processor's drive shaft. The lower blade pair 12 is moulded into the hub 11.

As shown in FIG. 4, the upper blade pair 13 is moulded into a sleeve 41. The hub 11 is adapted to be assembled, preferably permanently, with the sleeve 41. As shown in FIG. 3, the hub has a cylindrical portion 35 located between the upper and lower blade pairs 12, 13. FIG. 4 illustrates that this cylindrical portion 35 terminates in a series of (for example) equally spaced locating teeth 36 that are spaced apart around the receiving shoulder 37 and located generally above the upper blade pair 13. A receiving groove 38 is formed into the surface of the hub 11.

As suggested by FIGS. 3 and 4, the sleeve 41 features an upper inwardly flanged rim 42 having an inside diameter that fits within the groove 38. The inside diameter of the flange is thus nominally smaller in diameter than those portions of the hub adjacent the groove 38. During manufacture, the sleeve 41 with its moulded in blades 13 is urged over the hub 11. When finally and permanently seated, the notches 43 that surround the lower opening of the sleeve engage with the cooperating teeth 36. The arrangement of teeth 36 and notches 43 act as a means for transmitting torque from the rotating hub 11 to the upper blade pair 13. To restrict the axial movement of the sleeve 41, the upper rim 42 is trapped by the groove 38. It expands slightly as it is urged on to the hub, eventually returning to its resting shape within the groove 38. In order to prevent debris from entering the space between the hub 11 and the sleeve 41 polymer, sealing rings 44, 45 may be provided variously in the circumferential gap 38 formed adjacent the teeth 37 and in a circumferential gap 39 formed between the lower extent of the sleeve 41 and the upper end or shoulder of the cylindrical portion 35 of the hub 11.

Note that both the sleeve 41 and the hub 11 feature conforming flanges 50 both above and below each blade. The flanges 50 increase the bonding area in the area of the blades.

While the present invention has been disclosed with reference to particular features and details of construction, these should be understood as having been provided by way of example and not as limitations to the scope or spirit of the invention. In particular, the shape of the cutting edge and the shape of the double bladed blanks are not considered essentially to the scope or spirit of the invention.

What is claimed is:

1. A multiple blade accessory device for a food processor, comprising:
a hollow hub that is adapted to carry a pair of lower blades and a pair of upper blades;
the lower blades and the upper blades being similar, each formed from a single blank;
each blank being formed to present two cutting edges, diametrically opposed;
the upper blade pair is moulded into a separate sleeve;
the hub being adapted to be assembled with the sleeve.

2. The device of claim 1, wherein:
the blade pairs are arranged one above the other and in vertical alignment.

3. The device of claim 1, wherein:
the cutting edges are in different planes so as to present four cutting planes.

4. The device of claim 1, wherein:
the hub comprises a relatively thin walled moulding having an open lower end and a tapered tip.

5. The device of claim 4, wherein:
the tip has a top end in which is formed a central opening;
an interior of the tip comprises a spline that is drivable by a cooperating portion of a food processor's drive shaft.

6. The device of claim 1, wherein:
the lower blade pair is moulded into the hub.

7. The device of claim 1, wherein:
the hub being adapted to be assembled, permanently, with the sleeve.

8. The device of claim 1, wherein:
the hub has a cylindrical portion located between the upper and lower blade pairs terminating in a series of locating teeth.

9. The device of claim 9, wherein:
a receiving groove is formed into a surface of the hub.

10. The device of claim 1, wherein:
the sleeve features an upper inwardly flanged rim having an inside diameter that fits within a groove formed into a surface of the hub.

11. The device of claim 10, wherein:
an inside diameter of the rim is nominally smaller in diameter than portions of the hub adjacent the groove.

12. The device of claim 1, wherein:
the sleeve is urged over the hub to seat it permanently;
and notches that surround a lower opening of the sleeve engage with cooperating teeth as a means for transmitting torque from the hub to the upper blade pair.

13. The device of claim 1, wherein:
an upper rim of the sleeve is trapped by a groove, the sleeve expanding slightly as it is urged on to the hub, eventually returning to its resting shape within the groove.

14. The device of claim 12, wherein:
one or more polymer sealing rings are provided in a circumferential gap formed adjacent the teeth and in a circumferential gap formed between the lower extent of the sleeve and an upper end or shoulder of the cylindrical portion of the hub.

15. The device of claim 7, wherein:
either the sleeve or the hub feature conforming flanges either above or below each blade.
